(19) United States
(12) Patent Application Publication
(10) Pub. No.: US 2009/0194584 A1
(43) Pub. Date: Aug. 6, 2009

(54) ELECTRONIC HANDHELD BANK TRANSACTION REGISTER AND ASSOCIATED METHODOLOGY

(75) Inventors: Jerry M. Alexander, Allen, TX (US); LaDonna L. Searcy-Alexander, Allen, TX (US)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 12/024,255

(22) Filed: Feb. 1, 2008

(51) Int. Cl. G06Q 40/00

(52) U.S. Cl. 235/379

(57) ABSTRACT

An electronic, handheld transaction register device for indicating an account balance of a bank, or other, account that permits two or more parties to make transactions in the account independent of one another. When a transaction is made, a synchronization signal is generated and sent to the electronic, handheld transaction register device. Responsive to detection of the synchronization signal, a local transaction register is adjusted to reconcile the account. A display is generated, providing a user of the device with an up-to-date and accurate indication of the account balance.

The present invention relates generally to a manner by which to reconcile transactions made to a bank account, such as a checking or savings account, at a handheld, electronic transaction book register. More particularly, the present invention relates to an apparatus, and an associated methodology, that automatically reconciles the transaction book register with transactions made by any party that debits or credits the bank account.

Transactions made in an account, such as a joint account, that permits more than one party independently to make transactions, are automatically reported to, and reconciled at, the transaction book register of the electronic transaction book register. An up-to-date, and accurate, account balance is maintained at the register, readily available for viewing by a user of the device.

### BACKGROUND OF THE INVENTION

Modern commerce relies upon monetary systems in which goods and services are exchanged in return for monetary instruments. As business, and other commerce, is oftentimes transacted between parties that are distant from one another in which the goods and services are to be provided at some future time, physical delivery of cash in payment for the goods or services is therefore sometimes inconvenient or impractical. Monetary instruments are therefore regularly used to make payment for many of the goods and services that are sold in commerce.

Monetary instruments such as checks and analogous instruments, provide a secure manner by which to make payment for the goods and services. A check is drawn on funds deposited in a bank account of a payor bank. The check is generally made payable to a payee, the party that is to provide the goods or services. The party to whom the check is paid presents the check for payment, such as presentment to a bank, the payee bank, at which the party maintains a bank account. The payee bank at which the check is presented for payment credits the account in which the check has been deposited or otherwise makes payment to the presenter. And, in turn, the bank presents the check for payment to the payor bank upon which the check was drawn.

Payment for goods or services is also a staple of economic commerce for personal transactions. For many, payment for goods and services is predominantly made by check or monetary instrument rather than by cash. And, increasingly, payment transactions are made in electronic form through electronic debits from bank accounts and electronic credits to bank accounts. Irrespective of the form, i.e., paper or electronic, payment for a significant portion of the goods and services that are transacted in modern commerce are made by such instruments rather than through payment by cash.

Recording the transactions becomes somewhat challenging as, even on a personal basis, sometimes dozens of transactions are made within a single month. The balance of an account is typically maintained at a transaction register, such as a check book register, savings account register, or analogous register. Maintenance of the transaction register becomes yet more difficult when the bank account is a joint account or otherwise is permitting of multiple parties to make transactions with monies of the account. When more than one party is able to make payments, i.e., debits, from the account, the payments might be made by one of the parties without knowledge of the other of the parties. The different parties, each maintaining different transaction registers might well indicate different amounts of monies in the account with neither of the parties accurately indicating the amounts that are actually in the account.

The transaction register is sometimes maintained as an electronic register. An account balance is stored at the electronic transaction register in electronic form. At least one electronic transaction register is embodied at a PDA (Personal Digital Assistant) that is provided with radio communication capabilities. And, at least one of such PDA-like devices further includes check writing capabilities as part of the functionality of the device.

While an electronic transaction register that is embodied at a PDA or is otherwise permitting of reception of transaction information provides various advantages, problems associated with multiple parties making transactions that affect the balance of the bank account without knowledge of other parties remain unresolved.

If an improved manner could be provided by which to inform all parties of transactions made with respect to a bank account, transaction register information would more likely be accurate.

It is in light of this background information related to bank account transactions that the significant improvements of the present invention have evolved.

### SUMMARY OF THE INVENTION

The present invention, accordingly, advantageously provides an apparatus, and an associated method, by which to reconcile transactions made at a bank account, such as a checking or savings account, at a handheld, electronic transaction book register.

Through operation of an embodiment of the present invention, a manner is provided by which to automatically reconcile the transaction book register with transactions made by any party that debits or credits the bank account.

In one aspect of the present invention, transactions made using the account, such as a joint account, that permits two or more parties independently to make transactions are automatically reported to, and reconciled with, the transaction book register. By reporting and reconciling the transaction book register with all transactions that are made, the transaction book register is maintained in up-to-date status with accurate account balance indications, easily accessible by a party that views the register contents.

In another aspect of the present invention, an electronic transaction register is provided that is of portable dimensions, e.g., of dimensions permitting hand-carriage by a user. The register includes an electronic memory capable of storing a register value that forms an account balance. And, the register includes a control entity configured to control the values stored at the storage element that forms the account balance. The control entity is provided with transaction information identifying all transactions made to the account.

In another aspect of the present invention, the transaction register includes a synchronization signal detector that detects broadcast of synchronization information that identifies transactions made to the associated account. When the account is a multi-party account, transactions can be made by two or more parties. For example, in a joint account, each of the joint owners of the account, or their agents, is able to make transactions to the account, i.e., credit monies into the account and debit monies out of the account. The synchronization signal detected by the detector includes at least identification of transactions made by a joint owner or agent other than the owner or agent that uses the transaction register. Thereby, through detection of the synchronization signal, the electronic transaction register is provided with indications of transactions made by others to the account, thereby to permit the register to accurately indicate the account balance of the associated account.

In another aspect of the present invention, the electronic transaction register further provides check-making, i.e., check-generative, capabilities. A user of the transaction book register is thereby capable of generating a check, in paper or electronic form, at the register. In whichsoever form, the generation of the check affects the account balance of the transaction register. In one implementation, an indication of the check amount is provided to the control entity, and the control entity causes the account balance stored in the storage element forming the register to be changed to indicate the debiting. In another implementation, a report is generated, and the information contained in the report is communicated to a network. And, subsequently, a subsequently-generated synchronization signal includes the transaction information.

In another aspect of the present invention, multiple electronic transaction registers are provided for multiple users, e.g., an electronic transaction register is provided for each of the joint owners of a joint bank account. The electronic transaction registers each include radio transceiver circuitry capable of reporting on locally-generated transactions and to detect synchronization signals that report on transactions made to the bank, or other, common, account. In operation, a user of an electronic transaction register is provided with indications of all transactions involving the underlying account, both transactions made by the user as well as transactions made by other users that affect the underlying account. The account balance of the underlying account is updated to reflect all transactions made by any of the parties, thereby to synchronize the transaction registers with one another.

In another aspect of the present invention, the electronic transaction register includes a user interface including a user input mechanism and a user display mechanism. The user interface includes, for instance, a touch screen display. Displays are generated on the touch screen in human perceptible form that provide a menu, or other visual indicia, responsive to which the user provides an input, such as by touching an appropriate portion of the display screen. In an implementation in which check-generative capabilities are provided to the transaction register, the user interface provides for the entry of check-related information, e.g., to whom the check is to be paid and the amount of the check. The user interface also provides a display screen for displaying the account balance maintained at the register.

In another aspect of the present invention, the detector of the transaction register further detects alerts, such as overdraft warnings or unusual transaction occurrences to the underlying bank account. And, responsive to detection of an alert, the user interface generates an alert in human perceptible form that alerts a user of the occurrence.

In another aspect of the present invention, a network node of a communication-system network provides a synchronization signal generator that operates to generate synchronization schedules that identify transactions made to a bank account that has multiple parties permitted to make transactions. The synchronization signal generator generates a synchronization signal to report on a transaction relating to the account.

Because an electronic transaction register is provided with indications of all transactions made to an account, the transaction register is maintained in up-to-date status with current account balance information.

In these and other aspects, therefore, an apparatus, and an associated methodology, is provided for facilitating bank-account, transaction reconciliation of a bank account. The bank account permits transactions by a first user and at least a second user. A local register is configured to register bank account transactions. A synchronization signal detector is configured to detect a synchronization signal that identifies a transaction made with the bank account by any of the first user and the second user. A reconciler is configured to reconcile the local register in conformity with the transaction identified in the synchronization signal.

A more complete appreciation of the scope of the present invention and the manner in which it achieves the above-noted and other improvements can be obtained by reference to the following detailed description of presently preferred embodiments taken in connection with the accompanying drawings which are briefly summarized below, and by reference to the appended claims.

### BRIEF DESCRIPTION OF THE DRAWINGS

FIG. 1 illustrates a functional block diagram of a system that provides for reconciliation of transactions involving a bank, or other, account that two or more parties are permitted independently to make transactions.

FIG. 2 illustrates a partial functional block, partial perspective view of an electronic handheld transaction register of an embodiment of the present invention.

FIG. 3 illustrates another view of the electronic, handheld transaction register shown in FIG. 2.

FIG. 4 illustrates another view of the electronic, handheld transaction register shown in FIGS. 2-3.

FIG. 5 illustrates a process diagram representative of the process of operation of an embodiment of the present invention.

FIG. 6 illustrates a method flow diagram representative of the method of operation of an embodiment of the present invention.

### DETAILED DESCRIPTION

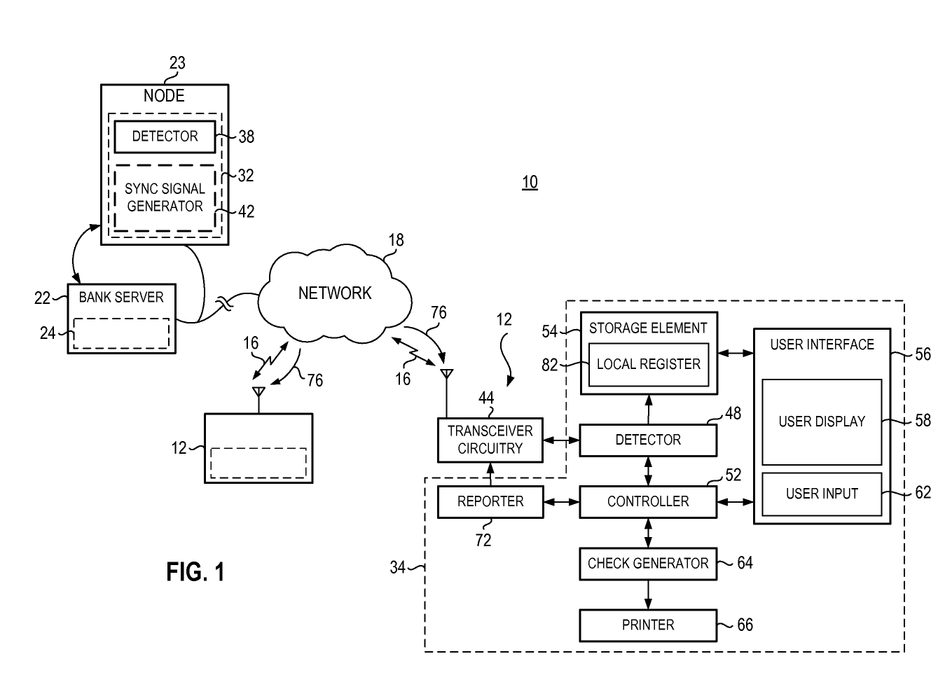

Referring first to FIG. 1, a system, shown generally at 10, provides for radio communications with electronic transaction register devices, of which two exemplary transaction register devices 12 are shown in the figure. Any of various radio technologies are used pursuant to the operation of the system 10, such as, e.g., any of various cellular communication technologies, WiFi technologies, WLAN (Wireless Local Area Network) technologies, or combinations thereof that utilize interworkings between various communication-system technologies. The communication technology defines a radio air interface that extends between a communication network 16 and the transaction register devices 12. In the exemplary system, a network 18 includes network entities that provide for the generation of signals that are sent on the radio air interface 16 for delivery to the transaction registers and network entities for detecting information sent thereto by the transaction registers. While not separately designated, the network 18, in the exemplary implementation, includes a radio access network part and a core network part. Communication entities are connectable to the network 18. For instance, nodes 22 and 23, here a server 22 and a communication node 23 connected thereto, are connected to the network 18 through which communication data is routed pursuant to operation of an embodiment of the present invention.

The bank server 22 stores bank-related information related to a banking enterprise. More generally, the bank server is representative of storage and processing entities of any of various business, and other, entities that provide for customer accounts. And, as used herein, bank services, accounts, etc. are intended to refer to, and include, account activity related to any of such various enterprises.

Of relevance to operation of an embodiment of the present invention, the bank server maintains account records associated with a bank account. The bank account is of any of various account-types, e.g., a checking account, savings account, deposit account, etc. The account is permitting of transactions to be made, i.e., debits and credits, to the account. The account forms, for instance, a joint checking or savings account.

The transaction register devices 12 maintain register entries that identify the account balance of the account 24. Multiple register devices 12 are provided. In the illustrated implementation, two register devices 12 are provided, available for use by separate users, here a first user operates a first register device 12 and a second user operates a second register device 12. For example, a first account owner of the account 24 operates a first of the register devices 12, and a second owner of the account 24 operates a second of the register devices. In other implementations, other numbers of register devices and other numbers of owners of the account 24 are analogously represented.

As noted previously, when multiple parties are permitted to make transactions with a single account, reconciling the account balance of the account is sometimes difficult. As the transactions are made independently, the transactions made by one of the parties is not necessarily, and frequently is not, immediately made known to the other of the parties. Reconciliation of the account balance, absent some type of notification, the actual account balance is unable to be maintained by the individual parties.

Operation of an embodiment of the present invention provides a manner by which to indicate to each of the transaction register devices 12 all transactions relating to the account 24. By providing the register devices with such indications, the reconciliation of the account balance of the associated account is able accurately to be maintained at the remote transaction register devices. The system 10, accordingly, includes apparatus 32 embodied at the network node 23, and the transaction register devices include apparatus 34 embodied at the respective register devices. The elements of the apparatus 32 and 34 are functionally represented, implementable in any desired form, including, e.g., at least in part, by algorithms executable by processing circuitry. And, while the elements of the respective apparatus 32 and 34 are shown embodied at single physical entities, in other implementations, the elements of the respective apparatus are distributed across more than one physical entity.

The apparatus 32 includes a detector 38 and a synchronization signal generator 42. The detector operates to detect transaction reports generated by transaction register devices or that otherwise represent transactions made with respect to the account 24. And, the synchronization signal generator operates to generate synchronization signals that are broadcast, or otherwise sent to the transaction register devices 12.

While the apparatus 34 is embodied at each of the register devices 12, only the apparatus 34 shown at the second register device 12 is shown in detail. The apparatus 34 embodied at the first register device 12 can be analogously represented. The apparatus 34 is coupled to transceiver circuitry 44 of the register. The transceiver circuitry 44 is, for instance, the transceiver circuitry of a conventional cellular, PDA, or other radio device.

The apparatus 34 includes a detector 48, a controller 52, a storage element 54, a user interface 56 having a user display 58 and a user input 62, a check generator 64, a printer 66, and a reporter 72. The apparatus provides both for the maintenance of an accurate account balance representative of the account balance of the account 24. The detector 48 operates to detect delivery of synchronization signal, here represented by the arrows 76 to the transaction register. The synchronization signal identifies transactions made to the account 24, and, in one implementation, also provides for alerts during anomaly conditions, such as overdraft conditions, or other unusual-activity conditions associated with the account. Detected information, detected by the detector is provided to the controller 52. The controller operates to control operation of the apparatus 34. And, the controller alters the contents of a local register 82 defined at the storage element 54 responsive to the detected information. When the information identifies a transaction, a debit or credit, to the account, the stored value at the local register is correspondingly altered to reflect the change in the account. The reconciled balance stored at the register is displayable at the user display 58 of the user interface 56. Thereby, responsive to detection of a synchronization signal, the contents of the local register are automatically updated and readily displayable, providing a user of the transaction register device with a display screen that identifies the actual balance of the account.

The transaction register device further includes check-generative capabilities, here permitting the user of the device to generate and to print a check or to generate an electronic check. The entity to which the check is to be paid and the amount of the check is entered by a user by way of the user input 62 of the user interface 56. Indications are provided to the check generator 64, either directly, or by way of the controller 52, and the check generator causes printing of a check by the printer 66. Alternately, if an electronic check is to be generated, indications are provided to a reporter 72 that causes a report to be generated and sent by way of the radio air interface for delivery to the enterprise at which the bank server 32 and network node 23 are associated. Additionally, if a paper check is generated, the generator also causes the reporter 72 to generate a report that is returned to the enterprise location and the account balance of the account 24 is correspondingly adjusted. The adjustment of the account balance of the account 24 is provided to the detector 38, and a synchronization signal indicative thereof is caused to be generated. Thereby, other transaction register devices, not parties to the generation of the check are informed of its generation and is able to maintain an updated balance at its local register.

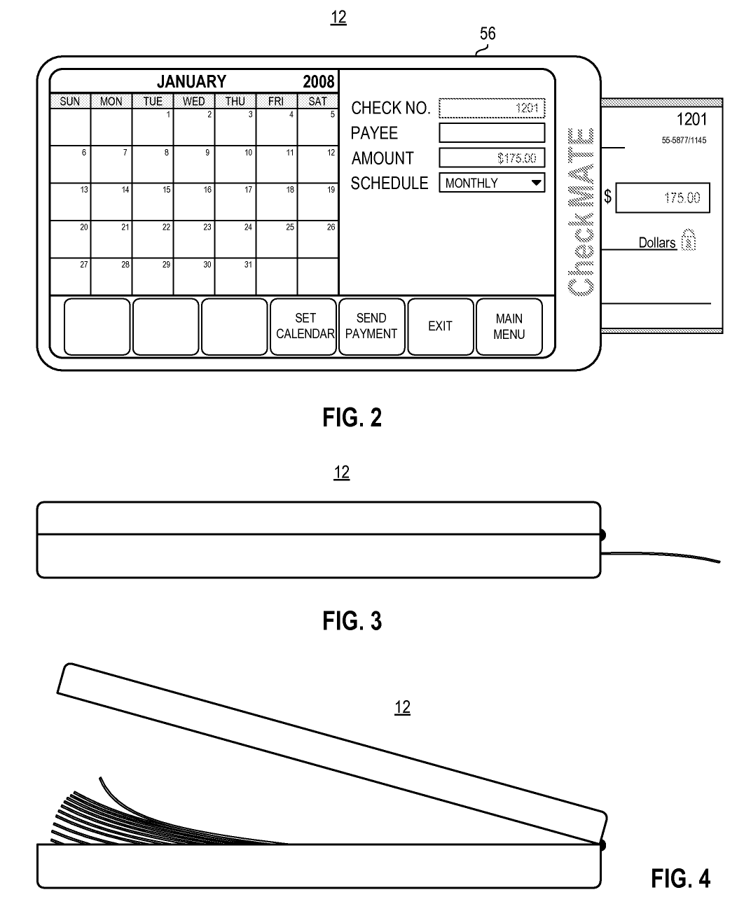

FIG. 2 illustrates a representation of an exemplary transaction register device 12 of an embodiment of the present invention. The user interface 56 of the register device forms an interactive touch screen display that functions both as a display and input entity. Here a screen display associated with generation of a check is illustrated. The amount of the check, the payee of the check and information associated with the check, here its due date, are displayed at the interactive touch screen display. Here also, the display provides a calendar display of a monthly calendar. Periodic payment due dates, for instance, are able to be indicated on the calendar. The illustration of the figure further illustrates commencement of generation of a check in conformity with the information displayed at the user interface. Any of various other screen displays, and interactive touch screen displays, are formed at the user interface.

FIG. 3 illustrates another view of the electronic transaction register device 12. Here, again, the device is illustrated during generation of a check. And, FIG. 4 illustrates another representation of the register device, here in a partially-opened position, showing checks positioned within the device.

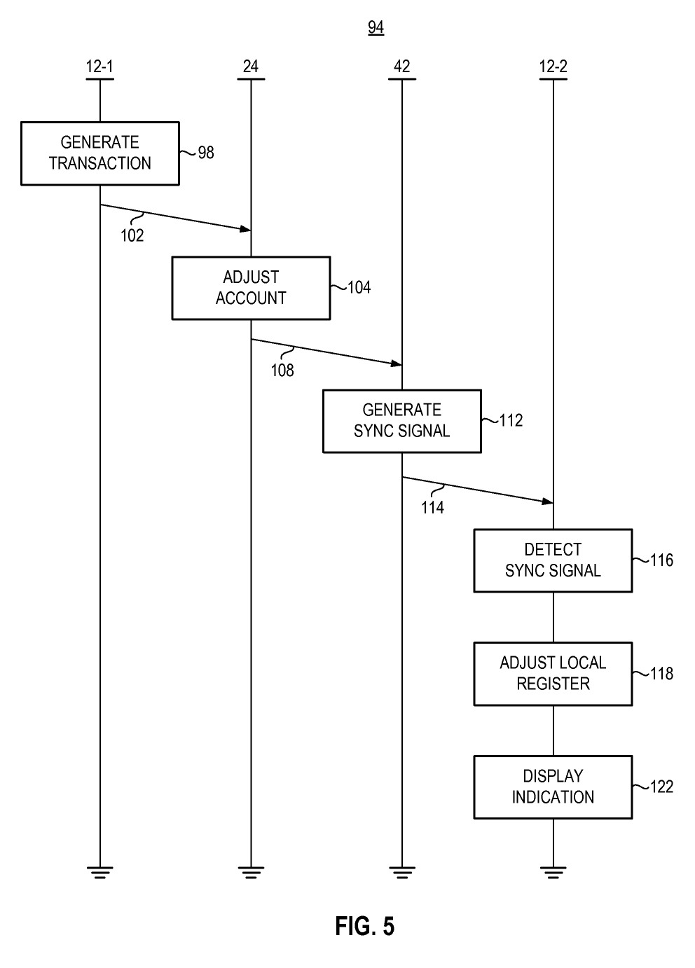

FIG. 5 illustrates a process diagram, shown generally at 94, representative of the process of operation of an embodiment of the present invention. Exemplary operation represented by the process 94 shows the manner by which the local transaction register of a second transaction register device is reconciled responsive to generation of a check by another party, here a party that generates a check using a first transaction register device.

First, and as indicated by the block 98, the first transaction is generated, here by generation of a check, in either paper or in electronic form. A transaction report is generated and sent, indicated by the segment 102. The report is routed through a communication network and provided to the server 22 at which the account 24 is maintained. The account is adjusted, indicated by the block 104, and an indication of the adjustment is provided, indicated by the segment 108, to the synchronization signal generator. The synchronization signal generator generates a synchronization signal, indicated by the block 112, and the synchronization signal is sent, indicated by the segment 114, to the second transaction register device 12.

The second transaction register device 12 detects, indicated by the block 116, the synchronization signal. And, responsive to the detection, the local register is adjusted, indicated by the block 118. And, once adjusted, i.e., reconciled, the adjusted register value is displayed, indicated by the block 122.

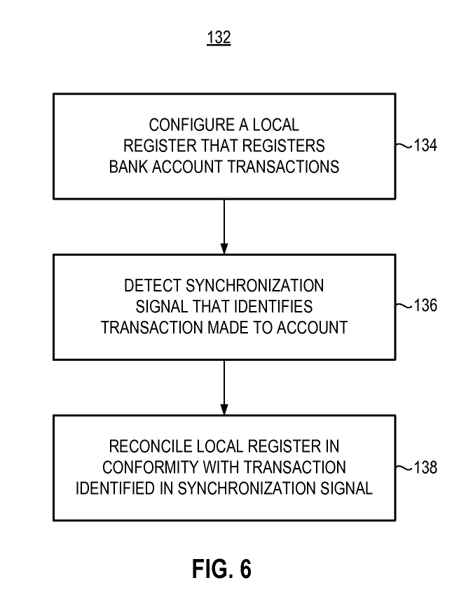

FIG. 6 illustrates a method flow diagram, shown generally at 132, representative of the method of operation of an embodiment of the present invention. The method facilitates bank-account transaction reconciliation of a bank account that permits transactions by a first user and at least a second user.

First, and as indicated by the block 134, a local register that registers bank account transactions is configured. Then, and as indicated by the block 136, a synchronization signal that identifies a transaction made with the bank account by any of the first user and the second user is detected. Then, and as indicated by the block 138, the local register is reconciled in conformity with the transaction. Thereby, the local transaction register is automatically reconciled with the underlying account. Inaccurate account balance indications at the local transaction register resulting from the lack of information associated with transactions made by another authorized party, such as a joint owner, does not occur.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. An apparatus for facilitating bank-account, transaction reconciliation of a bank account permitting transactions by a first user and at least a second user, said apparatus comprising:
a local register configured to register band account transactions;
a synchronization signal detector configured to detect a synchronization signal that identifies a transaction made with the bank account by any of the first user and the second user; and
a reconciler configured to reconcile the local register in conformity with the transaction identified in the synchronization signal detected by said synchronization signal detector.

2. The apparatus of claim 1 further comprising a check generator configured to generate a check drawn on the bank account.

3. The apparatus of claim 2 wherein said local register is further configured to register a debit at said local register responsive to generation of the check drawn on the bank account.

4. The apparatus of claim 2 further comprising a user interface configured to provide for user entry of check information for the check generated by said check generator.

5. The apparatus of claim 4 wherein said user interface comprises an interactive touch screen.

6. The apparatus of claim 1 further comprising or user interface configured to display information of said local register in human perceptible form.

7. The apparatus of claim 1 further comprising a user interface configured to display information associated with the synchronization signal detected by said synchronization signal detector in human perceptible form.

8. The apparatus of claim 1 further comprising a user interface configured to display in human perceptible form reconciliations made by said reconciler.

9. The apparatus of claim 1 wherein the synchronization signal detected by said synchronization signal detector further comprises alert information.

10. The apparatus of claim 1 wherein the synchronization signal detected by said detector further comprises discrepancy information.

11. The apparatus of claim 1 wherein the synchronization signal detected by said detector further comprises overdraft information.

12. The apparatus of claim 1 wherein said reconciler is configured to automatically reconcile said local register in conformity with the transaction identified in the synchronization signal.

13. A method for facilitating bank-account transaction reconciliation of a bank account permitting transactions by a first user and at least a second user, said method comprising:
configuring a local register that registers bank account transactions;
detecting a synchronization signal that identifies a transaction made with the bank account by any of the first user and the second user; and
reconciling the local register in conformity with the transaction identified in the synchronization signal.

14. The method of claim 13 further comprising displaying information associated with information maintained at the local register.

15. The method of claim 13 further comprising displaying information of the synchronization signal.

16. The method of claim 13 further comprising displaying information associated with reconciliation made during said reconciliating.

17. The method of claim 13 wherein said reconciliating is performed automatically.

18. The method of claim 13 wherein the synchronization signal further comprises alert information.

19. An apparatus for facilitating bank-account, transaction reconciliation of a bank account permitting transactions by a first user and at least a second user, said apparatus comprising:
a detector configured to detect a transaction report relating to any of a first-user bank account transaction and at least a second-user bank account transaction; and
a synchronization signal generator configured to generate a synchronization signal that identifies the transaction report detected by said detector.

20. The apparatus of claim 19 wherein said synchronization signal generator is further configured to generate a synchronization signal that alerts an overdraft occurrence.
